(19) United States
(12) Patent Application Publication
(10) Pub. No.: US 2024/0234800 A9
(43) Pub. Date: Jul. 11, 2024

(54) FLUORIDE ION CONDUCTIVE POLYMERIC SOLID ELECTROLYTE, SOLID ELECTROLYTE MATERIAL INCLUDING THE SAME, FLUORIDE SHUTTLE BATTERY, AND METHOD FOR PRODUCING THE SAME

(71) Applicant: Panasonic Holdings Corporation, Osaka (JP)

(72) Inventors: SHIRO SEKI, Kanagawa (JP); REIKO HINOGAMI, Osaka (JP)

(21) Appl. No.: 18/395,694

(22) Filed: Dec. 25, 2023

Related U.S. Application Data
(63) Continuation of application No. PCT/JP2022/025008, filed on Jun. 23, 2022.

(30) Foreign Application Priority Data
Jul. 15, 2021 (JP) 2021-117452

(51) Int. Cl. H01M 10/0562; H01M 4/02; H01M 4/38; H01M 50/446

(52) U.S. Cl. CPC H01M 10/0562; H01M 4/387; H01M 50/446; H01M 2004/027; H01M 2004/028; H01M 2300/008; H01M 2300/0082

(57) ABSTRACT

A fluoride ion conductive polymeric solid electrolyte includes an ion conductive polymer, a metal fluoride, and an anion scavenger material. The anion scavenger material includes a compound having a molecular weight of greater than or equal to 175.

### BACKGROUND

### 1. Technical Field

The present disclosure relates to a fluoride ion conductive polymeric solid electrolyte, a solid electrolyte material including the same, a fluoride shuttle battery, and a method for producing the same.

### 2. Description of the Related Art

Lithium-ion secondary batteries are secondary batteries with high energy density that are widespread. Furthermore, lithium-ion all-solid-state batteries using a nonflammable inorganic solid electrolyte have been proposed and have been extensively researched and developed because of their high safety. Fluoride ion batteries using the shuttle of fluoride ions (F⁻) have been proposed as a type of batteries using such a solid electrolyte. Fluoride ion batteries have high theoretical energy density.

Among solid electrolytes usable in fluoride ion secondary batteries, for example, LA₁₋ₓAEₓF₃₋ₓ, that are tysonite compounds doped with an alkaline earth metal (J. Mat. Chem., 2011, 21, 17059 (hereinafter, Non Patent Literature 1)), and fluorite compounds Ca_{1-y}Ba_{y}F₂ (Dalton Trans., 2018, 47, 4105-4117 (hereinafter, Non Patent Literature 2)) are reported as having relatively high fluoride ionic conductivity and a wide potential window. In LA₁₋ₓAEₓF₃₋ₓ, x is greater than or equal to 0.01 and less than or equal to 0.2; “LA” indicates a rare earth metal, such as La or Ce; and “AE” indicates an alkaline earth metal, such as Ca, Sr, or Ba. In the fluorite compounds Ca_{1-y}Ba_{y}F₂, y is greater than or equal to 0.1 and less than or equal to 0.9. Furthermore, Japanese Unexamined Patent Application Publication No. 2019-16426 discloses that a fluoride ion conductive material containing lanthanum fluoride and strontium fluoride may be used in fluoride shuttle batteries.

Electrochemistry, 2020, 88, 310 (hereinafter, Non Patent Literature 3) discloses a polymeric solid electrolyte obtained by imparting fluoride ion conductivity to a lightweight and flexible polymer.

### SUMMARY

In one general aspect, the techniques disclosed here feature a fluoride ion conductive polymeric solid electrolyte including an ion conductive polymer, a metal fluoride, and an anion scavenger material, the anion scavenger material including a compound having a molecular weight of greater than or equal to 175.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a sectional view schematically illustrating a fluoride shuttle battery according to an embodiment of the present disclosure;

FIG. 2 is a graph illustrating results of measurement of the temperature dependence of the conductivity of fluoride ion conductive polymeric solid electrolytes obtained in EXAMPLES 1 to 3 and COMPARATIVE EXAMPLE 1;

FIG. 3 is a graph illustrating results of measurement of the temperature dependence of the conductivity of fluoride ion conductive polymeric solid electrolytes obtained in EXAMPLE 1, EXAMPLE 4, and EXAMPLE 5;

FIG. 4 is a graph illustrating results of a charge/discharge test of a fluoride shuttle battery obtained in EXAMPLE 1;

FIG. 5 is a graph illustrating results of a charge/discharge test of a fluoride shuttle battery obtained in EXAMPLE 3;

FIG. 6 is a graph illustrating results of a charge/discharge test of a fluoride shuttle battery obtained in EXAMPLE 5;

FIG. 7 is a graph illustrating results of a charge/discharge test of a fluoride shuttle battery obtained in EXAMPLE 6; and

FIG. 8 is a graph illustrating results of thermogravimetry of compounds used as anion scavenger materials in EXAMPLE 1 and COMPARATIVE EXAMPLE 1.

### DETAILED DESCRIPTIONS

The present disclosure provides a novel fluoride ion conductive polymeric solid electrolyte usable in fluoride shuttle batteries.

### Underlying Knowledge Forming Basis of the Present Disclosure

As described in “Description of the Related Art”, Non Patent Literature 3 discloses a polymeric solid electrolyte obtained by imparting fluoride ion conductivity to a lightweight and flexible polymer. In this polymeric solid electrolyte, 2,4,6-trimethoxyboroxine is added as an anion scavenger material to a polymer to facilitate the dissociation of a fluoride salt in the polymer, thus realizing high fluoride ion conductivity even at room temperature. However, additional studies made by the present inventors have newly found that a battery that uses the polymeric solid electrolyte disclosed in Non Patent Literature 3 as a solid electrolyte does not exhibit charge/discharge capacities and cannot operate as a battery.

The present inventors have carried out in-depth studies on fluoride ion conductive polymeric solid electrolytes that can be used in batteries. As a result, the present inventors have learnt that the above problem stems from the use of 2,4,6-trimethoxyboroxine as an anion scavenger material, and have ascertained that an appropriate anion scavenger material needs to be added to a polymeric solid electrolyte to enable use in batteries. The present inventors made extensive studies and have completed a polymeric solid electrolyte of the present disclosure described hereinbelow.

### Summary of Aspects of the Present Disclosure

A fluoride ion conductive polymeric solid electrolyte according to the first aspect of the present disclosure includes:

an ion conductive polymer;

a metal fluoride; and

an anion scavenger material. The anion scavenger material includes a compound having a molecular weight of greater than or equal to 175.

The fluoride ion conductive polymeric solid electrolyte according to the first aspect enables a fluoride shuttle battery to operate. That is, the fluoride ion conductive polymeric solid electrolyte according to the first aspect may be used in a fluoride shuttle battery. Furthermore, the fluoride ion conductive polymeric solid electrolyte according to the first aspect can offer a lightweight and flexible fluoride shuttle battery.

In the second aspect of the present disclosure, for example, in the fluoride ion conductive polymeric solid electrolyte according to the first aspect, when the compound included in the anion scavenger material is heated at a heat-up rate of 10° C./min, the temperature at which the weight of the compound is reduced to 80% of the weight of the compound at 30° C. may be greater than or equal to 120° C.

The fluoride ion conductive polymeric solid electrolyte according to the second aspect can offer a battery with higher capacity.

In the third aspect of the present disclosure, for example, in the fluoride ion conductive polymeric solid electrolyte according to the first or the second aspect, the ion conductive polymer may include a polyether polymer.

The fluoride ion conductive polymeric solid electrolyte according to the third aspect can exhibit still enhanced fluoride ion conductivity.

In the fourth aspect of the present disclosure, for example, in the fluoride ion conductive polymeric solid electrolyte according to the third aspect, the polyether polymer may include a polymer compound containing an alkylene oxide as a repeating unit in a molecule of the polymer compound, and the polymer compound may have a crosslinked structure.

The fluoride ion conductive polymeric solid electrolyte according to the fourth aspect can exhibit still enhanced fluoride ion conductivity.

In the fifth aspect of the present disclosure, for example, in the fluoride ion conductive polymeric solid electrolyte according to the fourth aspect, the molecule of the polymer compound may include polyethylene oxide.

The fluoride ion conductive polymeric solid electrolyte according to the fifth aspect can exhibit still enhanced fluoride ion conductivity.

In the sixth aspect of the present disclosure, for example, in the fluoride ion conductive polymeric solid electrolyte according to the fourth or the fifth aspect, the polymer compound may have a main chain including a polyether unit and a unit analogous to the polyether unit, and the polyether unit may have a structure including repetition of —CH₂CH₂O—.

The fluoride ion conductive polymeric solid electrolyte according to the sixth aspect can exhibit still enhanced fluoride ion conductivity.

In the seventh aspect of the present disclosure, for example, in the fluoride ion conductive polymeric solid electrolyte according to any one of the fourth to the sixth aspects, the polymer compound may contain a branched side chain having a free terminal chain.

The fluoride ion conductive polymeric solid electrolyte according to the seventh aspect can exhibit still enhanced fluoride ion conductivity.

In the eighth aspect of the present disclosure, for example, in the fluoride ion conductive polymeric solid electrolyte according to any one of the first to the seventh aspects, the metal fluoride may include sodium fluoride.

The fluoride ion conductive polymeric solid electrolyte according to the eighth aspect can exhibit still enhanced fluoride ion conductivity.

In the ninth aspect of the present disclosure, for example, in the fluoride ion conductive polymeric solid electrolyte according to any one of the first to the seventh aspects, the metal fluoride may include cesium fluoride.

The fluoride ion conductive polymeric solid electrolyte according to the ninth aspect can exhibit still enhanced fluoride ion conductivity.

In the tenth aspect of the present disclosure, for example, in the fluoride ion conductive polymeric solid electrolyte according to any one of the first to the ninth aspects, the compound included in the anion scavenger material may be 2,4,6-triphenylboroxine.

The fluoride ion conductive polymeric solid electrolyte according to the tenth aspect can offer a battery with higher capacity.

A composite solid electrolyte material according to the eleventh aspect of the present disclosure includes:

the fluoride ion conductive polymeric solid electrolyte according to any one of the first to the tenth aspects; and

a fluoride ion conductive inorganic solid electrolyte.

The composite solid electrolyte material according to the eleventh aspect can exhibit still enhanced fluoride ion conductivity compared to the fluoride ion conductive polymeric solid electrolyte. Thus, the composite solid electrolyte material according to the eleventh aspect may be used in a fluoride shuttle battery. Furthermore, the composite solid electrolyte material according to the eleventh aspect can offer a lightweight and flexible fluoride shuttle battery.

In the twelfth aspect of the present disclosure, for example, in the composite solid electrolyte material according to the eleventh aspect, the fluoride ion conductive inorganic solid electrolyte may have a fluoride ionic conductivity of greater than or equal to 1×10⁻⁸ S·cm⁻¹ at 25° C.

The composite solid electrolyte material according to the twelfth aspect can exhibit still enhanced fluoride ion conductivity and thus can offer a battery with higher capacity.

A fluoride shuttle battery according to the thirteenth aspect of the present disclosure includes:

a positive electrode;

a negative electrode; and

an electrolyte layer disposed between the positive electrode and the negative electrode. At least one selected from the group consisting of the positive electrode, the negative electrode, and the electrolyte layer includes the fluoride ion conductive polymeric solid electrolyte according to any one of the first to the tenth aspects, or the composite solid electrolyte material according to the eleventh or the twelfth aspect.

The fluoride shuttle battery according to the thirteenth aspect is lightweight and has excellent flexibility.

In the fourteenth aspect of the present disclosure, for example, in the fluoride shuttle battery according to the thirteenth aspect,

the positive electrode may include:
a positive electrode active material including a first metal element; and
a first solid electrolyte, and

the first solid electrolyte may include the fluoride ion conductive polymeric solid electrolyte according to any one of the first to the tenth aspects, or the composite solid electrolyte material according to the eleventh or the twelfth aspect.

The fluoride shuttle battery according to the fourteenth aspect can attain enhanced charge/discharge capacities.

In the fifteenth aspect of the present disclosure, for example, in the fluoride shuttle battery according to the fourteenth aspect, the first metal element may be at least one selected from the group consisting of copper and silver.

The fluoride shuttle battery according to the fifteenth aspect can attain enhanced charge/discharge capacities.

In the sixteenth aspect of the present disclosure, for example, in the fluoride shuttle battery according to any one of the thirteenth to the fifteenth aspects,

the negative electrode may include:
a negative electrode active material including a second metal element; and
a second solid electrolyte, and

the second solid electrolyte may include the fluoride ion conductive polymeric solid electrolyte according to any one of the first to the tenth aspects, or the composite solid electrolyte material according to the eleventh or the twelfth aspect.

The fluoride shuttle battery according to the sixteenth aspect can attain enhanced charge/discharge capacities.

In the seventeenth aspect of the present disclosure, for example, in the fluoride shuttle battery according to the sixteenth aspect, the second metal element may be at least one selected from the group consisting of lead and tin.

The fluoride shuttle battery according to the seventeenth aspect can attain enhanced charge/discharge capacities.

In the eighteenth aspect of the present disclosure, for example, in the fluoride shuttle battery according to any one of the thirteenth to the seventeenth aspects,

the electrolyte layer may include a third solid electrolyte, and

the third solid electrolyte may include the fluoride ion conductive polymeric solid electrolyte according to any one of the first to the tenth aspects, or the composite solid electrolyte material according to the eleventh or the twelfth aspect.

The fluoride shuttle battery according to the eighteenth aspect can attain enhanced charge/discharge capacities.

A method for producing a fluoride shuttle battery according to the nineteenth aspect of the present disclosure includes:

forming a positive electrode including a first solid electrolyte and a positive electrode active material, the positive electrode active material including a first metal element;

forming an electrolyte layer by applying ultraviolet light to a mixture including a crosslinkable polymer, a metal fluoride, and an anion scavenger material to crosslink the crosslinkable polymer, the crosslinkable polymer containing polyethylene oxide in a molecule of the crosslinkable polymer;

forming a negative electrode including a second solid electrolyte and a negative electrode active material, the negative electrode active material including a second metal element; and

joining the positive electrode, the electrolyte layer, and the negative electrode into one piece by arranging the electrolyte layer between the positive electrode and the negative electrode.

The method according to the nineteenth aspect can produce a lightweight and highly flexible fluoride shuttle battery.

### EMBODIMENTS OF THE PRESENT DISCLOSURE

Hereinafter, embodiments of the present disclosure will be described in detail with reference to the drawings.

### Fluoride Ion Conductive Polymeric Solid Electrolytes

A fluoride ion conductive polymeric solid electrolyte according to an embodiment of the present disclosure includes an ion conductive polymer, a metal fluoride, and an anion scavenger material. The anion scavenger material includes a compound having a molecular weight of greater than or equal to 175. Hereinbelow, the compound used as the anion scavenger material is written as the “compound A”.

The polymeric solid electrolyte according to the present embodiment can exhibit high fluoride ion conductivity even at room temperature (for example, 25° C.). Furthermore, the anion scavenger material including the compound A can fulfill its function sufficiently in the solid electrolyte even after the polymeric solid electrolyte according to the present embodiment is heat-treated in the process of producing a fluoride shuttle battery. Thus, the polymeric solid electrolyte according to the present embodiment enables a fluoride shuttle battery to operate. That is, the polymeric solid electrolyte according to the present embodiment may be used in a fluoride shuttle battery. Furthermore, the polymeric solid electrolyte according to the present embodiment is more flexible and more lightweight than the conventional inorganic solid electrolytes. Thus, the polymeric solid electrolyte according to the present embodiment can offer a lightweight and flexible fluoride shuttle battery.

The molecular weight of the compound A is greater than or equal to 175 and may be greater than or equal to 220. By virtue of the anion scavenger material including the compound A, the polymeric solid electrolyte according to the present embodiment can offer a battery with higher capacity. The upper limit of the molecular weight of the compound A is not particularly limited. For example, the molecular weight may be less than or equal to 500 for a reason of ion conductivity.

When the compound A is heated at a heat-up rate of 10° C./min, the temperature up to which the weight of the compound A is reduced to 80% of the weight of the compound A at a temperature at which heating is started may be greater than or equal to 120° C. or may be greater than or equal to 150° C. In thermogravimetry (TG) of the compound A, for example, the compound A is heated from 30° C. at a heat-up rate of 10° C./min in a nitrogen atmosphere to reduce the weight of the compound A to 80% relative to the weight (100% weight) of the compound A at the start of heating (namely, 30° C.). The “temperature up to which the weight is reduced to 80% of the weight before heating” is thus determined. For example, the weight change of the compound A by heating stems from physical or chemical changes, such as volatilization or decomposition of the compound A by heating. The upper limit is not particularly limited of the temperature up to which the weight of the compound A being heated at a heat-up rate of 10° C./min is reduced to 80% of the weight before heating; the upper-limit temperature may be, for example, less than or equal to 500° C.

The compound A may be 2,4,6-triphenylboroxine. 2,4,6-Triphenylboroxine has excellent thermal stability. Thus, the polymeric solid electrolyte according to the present embodiment that includes 2,4,6-triphenylboroxine as the anion scavenger material can offer a battery with higher capacity. The molecular weight of 2,4,6-triphenylboroxine is 242.0.

In the polymeric solid electrolyte according to the present embodiment, the anion scavenger material may composed solely of the compound A or may further include an additional substance having anion scavenging properties. When, for example, the anion scavenger materials include the compound A and an additional anion scavenger substance, the compound A may represent greater than or equal to 10 mass % or may represent greater than or equal to 90 mass % of the anion scavenger materials.

The ion conductive polymer used in the polymeric solid electrolyte according to the present embodiment may be a known polymer having ion conductivity. The ion conductive polymer may be a general ion conductive polymer. Examples include polyether polymers, polyacrylonitrile polymers, polymethyl methacrylate polymers, polyvinylidene fluoride polymers, and copolymers thereof. In particular, polyether polymers are preferably used. That is, the ion conductive polymer may include a polyether polymer. The polyether polymer may include a polymer compound that contains an alkylene oxide as repeating units in the molecule. The polymer compound may have a crosslinked structure. The polyether polymer may be a polymer compound that contains alkylene oxide repeating units in the main chain, or may be a polymer compound that contains alkylene oxide repeating units in the side chains. Examples of the polymer compounds containing alkylene oxide repeating units in the molecule include linear such polymer compounds, specifically, polymer chains having ether bonds as the main skeleton, such as polyethylene oxide (PEO), polypropylene oxide (PPO), polybutylene oxide (PBO), polyethylene oxide/polypropylene oxide block copolymer, polyethylene oxide/polybutylene oxide block copolymer, polyethylene oxide/polypropylene oxide/polybutylene oxide block copolymer, polybutylene oxide/polyethylene oxide/polybutylene oxide block copolymer, and polyethylene oxide/polybutylene oxide/polyethylene oxide block copolymer. Two or more of polyethylene oxide, polypropylene oxide, polybutylene oxide, and other polymer compounds may be used as a mixture depending on the purpose.

For example, the polymer compounds containing alkylene oxide repeating units in the molecule may contain polyethylene oxide in the molecule. The polyethylene oxide may be present in the main chain of the polymer compounds or may be present in a side chain. Hereinbelow, the polymer compounds containing polyethylene oxide in the molecule are written as the polymer compounds B. The polymer compounds B exhibit high ion conductivity. Thus, the polymeric solid electrolyte according to the present embodiment that includes the polymer compound B having such a configuration can exhibit still enhanced fluoride ion conductivity.

In the polymeric solid electrolyte according to the present embodiment, the polymer compound B may have a crosslinked structure. The polymer compound B having such a configuration enhances the microscopic viscosity (mobility) of the polymer chains. As a result, the polymeric solid electrolyte according to the present embodiment can exhibit still enhanced fluoride ion conductivity.

The polymer compound B may have a main chain including a polyether unit having a structure formed by repetition of —CH₂CH₂O—, and a unit analogous to the polyether unit. An example of such polymer compounds B is a polymer compound that has a main chain including a polyether unit A formed by repetition of —CH₂CH₂O— and a polyether unit B formed by repetition of —CH(CH₃)CH₂O—. The polymer compounds B having such a configuration are advantageous in that the compounds are unlikely to trap anions due to the electrostatic repulsion between the oxygen atoms in the polyether units and the anions, and thus a high anion transference number can be expected. Thus, the polymeric solid electrolyte according to the present embodiment can exhibit still enhanced fluoride ion conductivity. Examples of the units analogous to the polyether unit include the above propylene oxide —CH(CH₃)CH₂O—, and butylene oxide.

The polymer compounds B may contain a branched side chain having a free terminal chain. Examples of the branched side chains contained in the polymer compounds B include CH₂═CHCH₂—O—(CH₂CH₂O)ₙ—CH₃. The polymer compounds B having a branched side chain enhances the microscopic viscosity (for example, motility) of the polymer chains, and consequently the polymeric solid electrolyte according to the present embodiment can exhibit still enhanced fluoride ion conductivity.

In the polymeric solid electrolyte according to the present embodiment, for example, the metal fluoride may include sodium fluoride. In this case, the polymeric solid electrolyte according to the present embodiment can exhibit still enhanced fluoride ion conductivity.

In the polymeric solid electrolyte according to the present embodiment, for example, the metal fluoride may include cesium fluoride. Cesium fluoride has a lower lattice energy than sodium fluoride, and therefore the salt has a high tendency to dissociate. Furthermore, cesium has a large ionic radius and thus has low solvation and desolvation energies with respect to the ether oxygens in the polymer. Thus, the polymeric solid electrolyte according to the present embodiment can exhibit further enhanced fluoride ion conductivity.

The polymeric solid electrolyte according to the present embodiment may include the metal fluoride in such a way that the ratio of the number of moles of the metal fluoride to the number of moles of oxygen contained in the polymer (that is, [number of moles of the metal fluoride]/[number of moles of oxygen contained in the polymer]) is greater than or equal to 0.005 and less than or equal to 0.5 or is greater than or equal to 0.01 and less than or equal to 0.25.

The polymeric solid electrolyte according to the present embodiment may include the anion scavenger material in such a way that the ratio of the number of moles of the anion scavenger material to the number of moles of oxygen contained in the polymer (that is, [number of moles of the anion scavenger material]/[number of moles of oxygen contained in the polymer]) is greater than or equal to 0.005 and less than or equal to 0.5 or is greater than or equal to 0.01 and less than or equal to 0.1.

In the polymeric solid electrolyte according to the present embodiment, the molar ratio of the metal fluoride to the anion scavenger material (that is, [number of moles of the metal fluoride]/[number of moles of the anion scavenger material]) may be greater than or equal to 0.5 and less than or equal to 5 or may be greater than or equal to 0.8 and less than or equal to 1.2.

### Composite Solid Electrolyte Materials

A composite solid electrolyte material of the present disclosure includes the fluoride ion conductive polymeric solid electrolyte according to the embodiment described above, and a fluoride ion conductive inorganic solid electrolyte. That is, the composite solid electrolyte material according to the present embodiment is a mixture of the polymeric solid electrolyte and an inorganic solid electrolyte.

The composite solid electrolyte material according to the present embodiment can exhibit still enhanced fluoride ion conductivity and thus can offer a battery with higher capacity. Furthermore, the composite solid electrolyte material of the present disclosure also has flexibility and thus can offer a battery that is resistant to cracks compared to batteries having an inorganic solid electrolyte as the only solid electrolyte.

For example, the fluoride ion conductive inorganic solid electrolyte may have a fluoride ionic conductivity of greater than or equal to 1×10⁻⁸ S·cm⁻¹ at 25° C. With this configuration, the composite solid electrolyte material according to the present embodiment can exhibit still enhanced fluoride ion conductivity and thus can offer a battery with higher energy density.

### Fluoride Shuttle Batteries

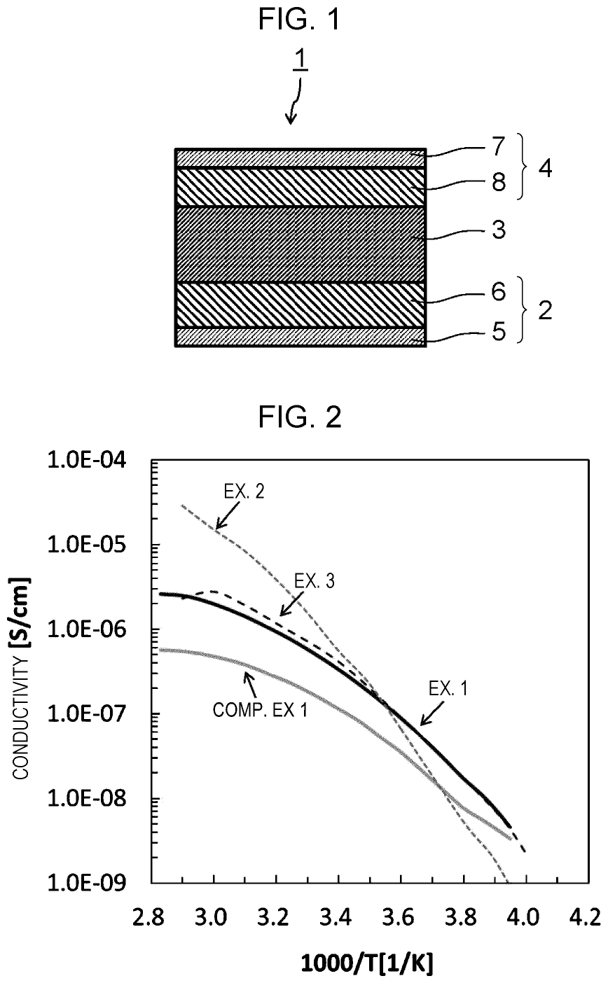

FIG. 1 is a sectional view schematically illustrating a fluoride shuttle battery according to an embodiment of the present disclosure. The fluoride shuttle battery 1 illustrated in FIG. 1 includes a positive electrode 2, an electrolyte layer 3, and a negative electrode 4. At least one selected from the group consisting of the positive electrode 2, the negative electrode 4, and the electrolyte layer 3 includes the fluoride ion conductive polymeric solid electrolyte according to the embodiment described above, or the composite solid electrolyte material according to the embodiment described above. The fluoride shuttle battery according to the present embodiment is lightweight and highly flexible.

The electrolyte layer 3 is disposed between the positive electrode 2 and the negative electrode 4. For example, the positive electrode 2 includes a positive electrode current collector 5 and a positive electrode active material layer 6. For example, the negative electrode 4 includes a negative electrode current collector 7 and a negative electrode active material layer 8.

The positive electrode active material layer 6 includes a positive electrode active material. The positive electrode active material is a material that can absorb and desorb fluoride ions when the fluoride shuttle battery 1 is charged and discharged. The absorption and desorption of fluoride ions may be chemical reactions or may occur without chemical reactions, for example, intercalation. The chemical reactions may form compounds or may form composites that are not compounds, such as alloys or solid solutions.

The positive electrode active material may be a material that has a standard electrode potential more positive than a negative electrode active material paired with the positive electrode active material in the fluoride shuttle battery 1.

For example, the positive electrode active material layer 6 in the positive electrode 2 may include a positive electrode active material including a first metal element, and a first solid electrolyte. In this case, the first solid electrolyte may be the fluoride ion conductive polymeric solid electrolyte according to the embodiment described hereinabove or the composite solid electrolyte material according to the embodiment described hereinabove.

By virtue of the positive electrode 2 having the above configuration, the fluoride shuttle battery 1 can attain enhanced charge/discharge capacities.

For example, the first metal element may be at least one element selected from the group consisting of Cu, Bi, Pb, Sb, Fe, Zn, Ni, Mn, Sn, Ag, Cr, In, Ti, and Co. In the positive electrode 2, the first metal element may be an elemental metal, a composite, such as an alloy or a solid solution, or a compound. For example, the compound of the first metal element is a fluoride. The fluoride shuttle battery 1 that includes the positive electrode 2 containing such a first metal element can attain enhanced charge/discharge capacities.

The first metal element may be at least one selected from the group consisting of Cu and Ag. In this case, the fluoride shuttle battery 1 can attain further enhanced charge/discharge capacities.

For example, the thickness of the positive electrode active material layer 6 is 1 to 500 μm. The thickness of the positive electrode active material layer 6 may be 1 to 400 μm or may be 50 to 200 μm. When the thickness of the positive electrode active material layer 6 is in the above ranges, the fluoride shuttle battery 1 can attain further enhancements in energy density and can be operated more stably at high output.

The negative electrode active material layer 8 includes a negative electrode active material. The negative electrode active material is a material that can absorb and desorb fluoride ions when the battery is charged and discharged. The absorption and desorption of fluoride ions may be chemical reactions or may occur without chemical reactions, for example, intercalation. The chemical reactions may form compounds or may form composites that are not compounds, such as alloys or solid solutions.

The negative electrode active material may be a material that has a standard electrode potential more negative than the positive electrode active material paired with the negative electrode active material in the fluoride shuttle battery 1.

For example, the negative electrode active material layer 8 in the negative electrode 4 may include a negative electrode active material including a second metal element, and a second solid electrolyte. In this case, the second solid electrolyte may be the fluoride ion conductive polymeric solid electrolyte according to the embodiment described hereinabove or the composite solid electrolyte material according to the embodiment described hereinabove.

By virtue of the negative electrode 4 having the above configuration, the fluoride shuttle battery 1 can attain enhanced charge/discharge capacities.

For example, the second metal element may be at least one element selected from the group consisting of Pb, Fe, Zn, Mn, Sn, Cr, In, Ti, Co, Al, Zr, La, Ba, Ca, Ce, and Sr. In the negative electrode 4, the second metal element may be an elemental metal, a composite, such as an alloy or a solid solution, or a compound. For example, the compound of the second metal element is a fluoride. The fluoride shuttle battery 1 that includes the negative electrode 4 containing such a second metal element can attain enhanced charge/discharge capacities.

In the negative electrode active material, the second metal element may be at least one selected from the group consisting of lead and tin. For example, the negative electrode active material may include Pb₁₋ₓSnₓF₂. Here, for example, x may satisfy 0≤x≤1, may satisfy 0<x<1, or may satisfy 0.32≤x≤0.47. When the second metal element is at least one selected from the group consisting of lead and tin, the fluoride shuttle battery 1 can attain further enhancements in charge/discharge capacities.

For example, the thickness of the negative electrode active material layer 8 is 1 to 500 μm. The thickness of the negative electrode active material layer 8 may be 1 to 400 μm or may be 50 to 200 μm. When the thickness of the negative electrode active material layer 8 is in the above ranges, the fluoride shuttle battery 1 can attain further enhancements in energy density and can be operated more stably at high output.

In the positive electrode 2, for example, the positive electrode active material layer 6 may include a conductive assistant. Furthermore, in the negative electrode 4, for example, the negative electrode active material layer 8 may include a conductive assistant. The addition of a conductive assistant may reduce the resistance of the positive electrode 2 and the negative electrode 4.

The conductive assistant is not limited as long as having electron conductivity. Examples of the conductive auxiliaries include graphites, such as natural graphite and artificial graphite; carbon blacks, such as acetylene black and Ketjen black; conductive fibers, such as carbon fibers and metal fibers; carbon fluoride; metal powders, such as aluminum; conductive whiskers, such as zinc oxide and potassium titanate; conductive metal oxides, such as titanium oxide; and conductive polymer compounds, such as polyaniline, polypyrrole, and polythiophene. The cost of the fluoride shuttle battery 1 may be reduced by using carbonous conductive auxiliaries, such as graphites and carbon blacks.

When any of the layers includes a particulate material, the layer may further include a binder that binds the particles together. The binder can enhance the integrity of the particles in the layer. Furthermore, the binder can enhance joint properties (bond strength) with respect to an adjacent layer. When, for example, the positive electrode active material layer 6 or the negative electrode active material layer 8 includes a particulate material, the addition of a binder to the active material layer can enhance joint properties between the active material layer and the current collector layer 5 or 7 adjacent to the active material layer. This enhancement in joint properties contributes to thinning of the layers because, for example, particles of the electrode active material can be brought into contact with one another more reliably in the positive electrode active material layer 6 and the negative electrode active material layer 8. Thinning of the layers makes it possible to further enhance the energy density of the fluoride shuttle battery 1.

The binder is not limited. For example, the binder may be a binder composed of a fluororesin or may be a polymer compound or a rubbery polymer. Examples of the fluororesins forming the binders include polyvinylidene fluoride (PVdF), polytetrafluoroethylene (PTFE), tetrafluoroethylene-hexafluoropropylene copolymer (FEP), tetrafluoroethylene-hexafluoroethylene copolymer, Teflon (registered trademark) binder, poly(vinylidene fluoride), tetrafluoroethylene-perfluoroalkyl vinyl ether copolymers (PFA), vinylidene fluoride-hexafluoropropylene copolymer, vinylidene fluoride-chlorotrifluoroethylene copolymer, ethylene-tetrafluoroethylene copolymer (ETFE), polychlorotrifluoroethylene (PCTFE), vinylidene fluoride-hexafluoropropylene-tetrafluoroethylene copolymer, vinylidene fluoride-perfluoromethyl vinyl ether-tetrafluoroethylene copolymer, and ethylene-chlorotrifluoroethylene copolymer (ECTFE). Examples of the polymer compounds include carboxymethylcellulose, polyacrylonitrile, polyethylene oxide, polypropylene oxide, polyvinyl chloride, polymethyl methacrylate, polymethyl acrylate, polymethacrylic acid, polyacrylic acid, polyvinyl alcohol, polyvinylidene chloride, polyethyleneimine, polymethacrylonitrile, polyvinyl acetate, polyimide, polyamic acid, polyamideimide, polyethylene, polypropylene, ethylene-propylene-diene terpolymer, polyvinyl acetate, nitrocellulose, ethylene-acrylic acid copolymer, ethylene-methacrylic acid copolymer, ethylene-methyl acrylate copolymer, ethylene-methyl methacrylate copolymer, polyester resins, monoalkyltrialkoxysilane polymers, and copolymers of monoalkyltrialkoxysilane polymers with tetraalkoxysilane monomers. Examples of the rubbery polymers include styrene-butadiene rubber (SBR), butadiene rubber (BR), styrene-isoprene copolymer, isobutylene-isoprene copolymer (butyl rubber), acrylonitrile-butadiene rubber, ethylene-propylene-diene copolymer, acrylonitrile-butadiene copolymer (NBR), hydrogenated SBR, hydrogenated NBR, ethylene-propylene-dienemer (EPDM), and sulfonated EPDM.

When the binder is an insulating material that does not conduct fluoride ions and/or electrons and is present in an excessively high content in each layer, charge/discharge characteristics of the battery may be lowered or the energy density may be reduced after all. From this point of view, the content of an insulating binder in the layer is, for example, less than or equal to 20 mass %, and may be less than or equal to 5 mass %.

The binder may have fluoride ion conductivity. Examples of the fluoride ion conductive binders include ion conductive polymers doped with metal fluorides. The fluoride ion conductive binders offer enhanced fluoride ion conductivity compared to insulating binders and are expected to enhance charge/discharge characteristics and the energy density.

The positive electrode current collector 5 and the negative electrode current collector 7 have electron conductivity. The positive electrode current collector 5 and the negative electrode current collector 7 may be composed of materials that have electron conductivity and are resistant to corrosion under environments in which the fluoride shuttle battery 1 is charged and discharged.

For example, the positive electrode current collector 5 is composed of a metal material, such as aluminum, gold, platinum, or an alloy thereof. The shape of the positive electrode current collector 5 is not limited and is, for example, a sheet or a film. The positive electrode current collector 5 may be a porous or non-porous sheet or film. The sheets and films may be foils and meshes. Aluminum and alloys thereof are inexpensive and easily thinned. The positive electrode current collector 5 may be composed of carbon-coated aluminum. For example, the thickness of the positive electrode current collector 5 is 1 to 30 μm. When the thickness of the positive electrode current collector 5 is in this range, the strength of the current collector may be ensured more reliably and, for example, the current collector resists cracking and rupture, and further the energy density of the fluoride shuttle battery 1 may be ensured more reliably.

The positive electrode current collector 5 may have a positive electrode terminal.

For example, the negative electrode current collector 7 is composed of a metal material, such as gold, platinum, aluminum, or an alloy thereof. The shape of the negative electrode current collector 7 is not limited and is, for example, a sheet or a film. The negative electrode current collector 7 may be a porous or non-porous sheet or film. The sheets and films may be foils and meshes. Aluminum and alloys thereof are inexpensive and easily thinned. The negative electrode current collector 7 may be composed of carbon-coated aluminum. For example, the thickness of the negative electrode current collector 7 is 1 to 30 μm. When the thickness of the negative electrode current collector 7 is in this range, the strength of the current collector may be ensured more reliably and, for example, the current collector resists cracking and rupture, and further the energy density of the fluoride shuttle battery 1 may be ensured more reliably.

The electrolyte layer 3 is a layer that conducts fluoride ions in the thickness direction, that is, in the direction in which the positive electrode 2 and the negative electrode 4 are stacked. Typically, the electrolyte layer 3 does not have electron conductivity in the thickness direction. For example, the thickness of the electrolyte layer 3 is 1 to 1000 μm. The thickness of the electrolyte layer 3 may be 200 to 800 μm or may be 300 to 700 μm. The electrolyte layer 3 having a thickness in the above ranges suppresses electrical short-circuiting between the positive electrode 2 and the negative electrode 4 and more reliably exhibits fluoride ion conductivity. The realization of more reliable fluoride ion conductivity enables the fluoride shuttle battery 1 to attain higher output characteristics.

The electrolyte layer 3 may include a third solid electrolyte. In this case, the third solid electrolyte may be the fluoride ion conductive polymeric solid electrolyte according to the embodiment described hereinabove or the composite solid electrolyte material according to the embodiment described hereinabove.

When the electrolyte layer 3 has the above configuration, the fluoride shuttle battery 1 can attain enhancements in charge/discharge capacities.

The electrolyte layer 3 may include a material other than the fluoride ion conductive polymeric solid electrolyte and the composite solid electrolyte material.

The fluoride shuttle battery 1 according to the present embodiment may be produced by any method without limitation. When, for example, the electrolyte layer 3 is composed of a polymeric solid electrolyte that includes an ion conductive polymer containing polyethylene oxide in the main chain and having a crosslinked structure, the fluoride shuttle battery 1 according to the present embodiment may be produced by, for example, a method for producing a fluoride shuttle battery that includes:

forming a positive electrode including a positive electrode active material including a first metal element, and a first solid electrolyte;

applying ultraviolet light to a mixture including a crosslinkable polymer containing polyethylene oxide in the main chain, a metal fluoride, and an anion scavenger material to crosslink the crosslinkable polymer, thereby forming an electrolyte layer;

forming a negative electrode including a negative electrode active material including a second metal element, and a second solid electrolyte; and

arranging the electrolyte layer between the positive electrode and the negative electrode, and joining the positive electrode, the electrolyte layer, and the negative electrode into one piece.

### EXAMPLES

The present disclosure will be described in greater detail below based on EXAMPLES. The following EXAMPLES are only illustrative and are not limiting.

### Example 1

### Fabrication of Electrolyte Layer

In a glove box under an argon gas atmosphere, NaF as a metal fluoride serving as a fluoride ion source and 2,4,6-triphenylboroxine (TPBx) as an anion scavenger material were added to ELEXCEL (registered trademark) TA-210 (an 8:2 by mass copolymer of ethylene oxide and propylene oxide, manufactured by DKS Co., Ltd.) in such proportions that the [Na]/[O] ratio (by mol) would be 0.04 and NaF:TPBx=1:1 (by mol). The materials were dissolved to give a mixture. To the mixture obtained, 2,2-dimethoxyacetophenone (DMPA) as a photopolymerization initiator was added in an amount of 0.1 part by mass with respect to 100 parts by mass of “TA-210”. The mixture was stirred.

Two glass plates and a 0.5 mm thick Teflon (registered trademark) spacer were provided. The mixture obtained was poured and sealed between the glass plates. The mixture was UV irradiated for 5 minutes to form a polymeric solid electrolyte sheet having a thickness of 0.5 mm. The polymeric solid electrolyte sheet thus obtained was cut to give a solid electrolyte layer with a diameter of 12 mm.

### Preparation of Binder Solution

In a glove box under an argon gas atmosphere, NaF as a fluoride ion source and TPBx as an anion scavenger material were added to P(EO/MEEGE) binder (a copolymer of EO: ethylene oxide and MEEGE: 2-(2-methoxyethoxy)ethyl glycidyl ether with EO:MEEGE molar ratio=0.88:0.12) manufactured by OSAKA SODA CO., LTD., in such proportions that the [Na]/[O] ratio (by mol) would be 0.04 and NaF:TPBx=1:2 (by mol), and acetonitrile was added and dissolved with a proportion of 90 mass %. A binder solution was thus prepared.

### Fabrication of Negative Electrode

Negative electrode active material Pb_{0.58}Sn_{0.42}F₂ (hereinafter, written as PSF) was prepared as follows. PbF₂ (manufactured by Kojundo Chemical Lab. Co., Ltd.) and SnF₂ (manufactured by Kojundo Chemical Lab. Co., Ltd.) were mixed in a mass ratio of 30:14. Next, the mixture was milled using a planetary ball mill at a rotational speed of 600 rpm for 24 hours.

The negative electrode active material PSF prepared as described above and acetylene black (AB) (manufactured by Denka Company Limited) as a conductive assistant were weighed in a mass ratio of PSF:AB=56:24 and were mixed together in an agate mortar. The resultant material was transferred to a glass bottle, and the binder solution was added with a proportion of 20 mass %. The mixture was stirred to give a uniform negative electrode slurry.

The negative electrode slurry was applied onto an aluminum foil as a negative electrode current collector so that the thickness would be 50 μm, and the solvent was removed by vacuum drying. A negative electrode active material layer was thus formed on the negative electrode current collector. The stack was cut to give a negative electrode with a diameter of 16 mm.

### Fabrication of Positive Electrode

Ag nanoparticles (manufactured by Sigma-Aldrich) as a positive electrode active material and acetylene black (AB) (manufactured by Denka Company Limited) as a conductive assistant were weighed in a mass ratio of Ag:AB=7:1 and were mixed together in an agate mortar. The resultant material was transferred to a glass bottle, and the binder solution was added with a proportion of 20 mass %. The mixture was stirred to give a uniform positive electrode slurry.

The positive electrode slurry was applied onto a copper foil as a positive electrode current collector so that the thickness would be 50 μm, and the solvent was removed by vacuum drying. A positive electrode active material layer was thus formed on the positive electrode current collector. The stack was cut to give a positive electrode with a diameter of 16 mm.

### Fabrication of Fluoride Shuttle Battery

The negative electrode, the solid electrolyte layer, and the positive electrode provided as described above were stacked in this order and were joined into one piece by annealing at 60° C. for one day. A battery was thus produced.

### Example 2

An electrolyte layer was fabricated as follows using CsF as a metal fluoride. In this EXAMPLE, only the electrolyte layer was fabricated, and no battery was produced.

### Fabrication of Electrolyte Layer

In a glove box under an argon gas atmosphere, CsF and TPBx were added to ELEXCEL (registered trademark) TA-210 in such proportions that the [Cs]/[O] ratio (by mol) would be 0.04 and CsF:TPBx=1:1 (by mol). The materials were dissolved to give a mixture. To the mixture obtained, photopolymerization initiator DMPA was added in an amount of 0.1 part by mass with respect to 100 parts by mass of “TA-210”. The mixture was stirred.

Two glass plates and a 0.5 mm thick Teflon (registered trademark) spacer were provided. The mixture obtained was poured and sealed between the glass plates. The mixture was UV irradiated for 5 minutes to form a polymeric solid electrolyte sheet having a thickness of 0.5 mm. The polymeric solid electrolyte sheet thus obtained was cut to give a polymeric solid electrolyte layer with a diameter of 12 mm.

### Example 3

A battery was produced in the same manner as in EXAMPLE 1, except that the electrolyte layer was formed using solid electrolyte materials including a fluoride ion conductive polymeric solid electrolyte and a fluoride ion conductive inorganic solid electrolyte.

### Preparation of Fluoride Ion Conductive Inorganic Solid Electrolyte

CeF₃ powder (manufactured by Kojundo Chemical Lab. Co., Ltd.) and SrF₂ powder (manufactured by Kojundo Chemical Lab. Co., Ltd.) were mixed in a molar ratio of CeF₃:SrF₂=95:5. Next, the mixture obtained was milled using a planetary ball mill for 43.5 hours. Next, the milled mixture was heat-treated in an inert gas atmosphere at 1100° C. for 1 hour. An inorganic solid electrolyte represented by the compositional formula Ce_{0.95}Sr_{0.05}F_{2.95} was thus obtained.

### Fabrication of Electrolyte Layer

In a glove box under an argon gas atmosphere, NaF and TPBx were added to ELEXCEL (registered trademark) TA-210 in such proportions that the [Na]/[O] molar ratio would be 0.04 and NaF:TPBx=1:1 (by mol). The materials were dissolved to give a mixture. To the mixture obtained, the fluoride ion conductive inorganic solid electrolyte Ce_{0.95}Sr_{0.05}F_{2.95} prepared as described above was added in an amount of 50 parts by mass with respect to 100 parts by mass of “TA-210”. The mixture was stirred. Next, photopolymerization initiator DMPA was added in an amount of 0.1 part by mass with respect to 100 parts by mass of “TA-210”. The mixture was stirred.

Two glass plates and a 0.5 mm thick Teflon (registered trademark) spacer were provided. The mixture obtained was poured and sealed between the glass plates. The mixture was UV irradiated for 5 minutes to form a composite solid electrolyte sheet having a thickness of 0.5 mm. The composite solid electrolyte sheet thus obtained was cut to give a composite solid electrolyte layer with a diameter of 12 mm.

### Example 4

In this EXAMPLE, only an electrolyte layer was fabricated, and no battery was produced. In the fabrication of the electrolyte layer, branched side chains were formed in a polymer as described below.

### Fabrication of Electrolyte Layer

In a glove box under an argon gas atmosphere, UNIOX (registered trademark) PKA-5006 (molecular weight 350, manufactured by NOF CORPORATION) for forming branched side chains was mixed with ELEXCEL (registered trademark) TA-210 so that the proportion of UNIOX (registered trademark) PKA-5006 would be 20 mass %. Furthermore, NaF and TPBx were added in such proportions that the [Na]/[O] ratio (by mol) would be 0.04 and NaF:TPBx=1:1 (by mol). The materials were dissolved to give a mixture. To the mixture obtained, DMPA as a photopolymerization initiator was added in an amount of 0.1 part by mass with respect to 100 parts by mass of “TA-210”. The mixture was stirred.

Two glass plates and a 0.5 mm thick Teflon (registered trademark) spacer were provided. The mixture obtained was poured and sealed between the glass plates. The mixture was UV irradiated for 5 minutes to form a polymeric solid electrolyte sheet having a thickness of 0.5 mm. The polymeric solid electrolyte sheet thus obtained was cut to give a polymeric solid electrolyte layer with a diameter of 12 mm.

### Example 5

A battery was produced in the same manner as in EXAMPLE 1, except that in the fabrication of the electrolyte layer, branched side chains were formed in a polymer as described below.

### Fabrication of Electrolyte Layer

In a glove box under an argon gas atmosphere, UNIOX (registered trademark) PKA-5006 (molecular weight 350, manufactured by NOF CORPORATION) for forming branched side chains was mixed with ELEXCEL (registered trademark) TA-210 so that the proportion of UNIOX (registered trademark) PKA-5006 would be 40 mass %. Furthermore, NaF and TPBx were added in such proportions that the [Na]/[O] ratio (by mol) would be 0.04 and NaF:TPBx=1:1 (by mol). The materials were dissolved to give a mixture. Next, DMPA as a photopolymerization initiator was added in an amount of 0.1 part by mass with respect to 100 parts by mass of “TA-210”. The mixture was stirred.

Two glass plates and a 0.5 mm thick Teflon (registered trademark) spacer were provided. The mixture obtained was poured and sealed between the glass plates. The mixture was UV irradiated for 5 minutes to form a polymeric solid electrolyte sheet having a thickness of 0.5 mm. The polymeric solid electrolyte sheet thus obtained was cut to give a polymeric solid electrolyte layer with a diameter of 12 mm.

### Example 6

A battery was obtained in the same manner as in EXAMPLE 1, except that the positive electrode was fabricated as described below using Cu as a positive electrode active material, and that the method for producing the fluoride shuttle battery was changed as described below.

### Fabrication of Positive Electrode

Cu nanoparticles (manufactured by Sigma-Aldrich) as a positive electrode active material and acetylene black (AB) (manufactured by Denka Company Limited) as a conductive assistant were weighed in a mass ratio of Cu:AB=7:1 and were mixed together in an agate mortar. The resultant material was transferred to a glass bottle, and the binder solution was added with a proportion of 20 mass %. The mixture was stirred to give a uniform positive electrode slurry.

The positive electrode slurry was applied onto a copper foil as a positive electrode current collector so that the thickness would be 50 μm, and the solvent was removed by vacuum drying. A positive electrode active material layer was thus formed on the positive electrode current collector. The stack was cut to give a positive electrode with a diameter of 16 mm.

### Fabrication of Fluoride Shuttle Battery

The negative electrode, the solid electrolyte layer, and the positive electrode provided as described above were stacked in this order and were joined into one piece by annealing at 120° C. for one week. A battery was thus produced.

### Comparative Example 1

A battery was produced in the same manner as in EXAMPLE 1, except that 2,4,6-trimethoxyboroxine (TMB) was used as the anion scavenger material in the fabrication of the electrolyte layer. The molecular weight of 2,4,6-trimethoxyboroxine (TMB) is 173.5.

### Evaluation of Fluoride Ionic Conductivity of Solid Electrolytes

The 0.5 mm thick solid electrolytes alone prepared as the electrolyte layers in EXAMPLES 1 to 5 and COMPARATIVE EXAMPLE 1 were each sandwiched between stainless steel electrodes (SUS304) in a glove box under an Ar atmosphere. The solid electrolytes each sandwiched between the stainless steel electrodes were placed into stainless steel measurement cells in the glove box under an Ar atmosphere.

Next, the measurement cells for EXAMPLES 1 to 5 and COMPARATIVE EXAMPLE 1 were taken out from the glove box, and the solid electrolytes of EXAMPLES 1 to 5 and COMPARATIVE EXAMPLE 1 were subjected to impedance measurement using a temperature variable electrochemical workstation (VSP manufactured by Bio-LOGIC, thermostatic chamber manufactured by ESPEC) while lowering the temperature from 80° C. to −26° C. under measurement conditions in which the frequency was 200 kHz to 50 mHz and the voltage applied was 100 mV. The temperature was lowered from 80° C. to 40° C. with a decrement of 10° C., and was lowered from 40° C. to −26° C. with a decrement of 5° C. The impedance was measured after the solid electrolytes of EXAMPLES 1 to 5 and COMPARATIVE EXAMPLE 1 were held at each temperature for 90 minutes until thermal stability was obtained. The values of resistance were read from the Nyquist plots of the measurement results, and the ionic conductivity was calculated.

FIG. 2 is a graph illustrating the results of measurement of the temperature dependence of the conductivity of the fluoride ion conductive polymeric solid electrolytes obtained in EXAMPLES 1 to 3 and COMPARATIVE EXAMPLE 1. In COMPARATIVE EXAMPLE 1 that involved a low-molecular weight anion acceptor, the conductivity was below the level of EXAMPLE 1. In EXAMPLE 2 in which the fluoride salt was changed from sodium fluoride to cesium fluoride, the conductivity was enhanced compared to EXAMPLE 1 at temperatures above room temperature. In EXAMPLE 3 in which the solid electrolyte material was a composite solid electrolyte material including an inorganic solid electrolyte, the conductivity was enhanced compared to EXAMPLE 1.

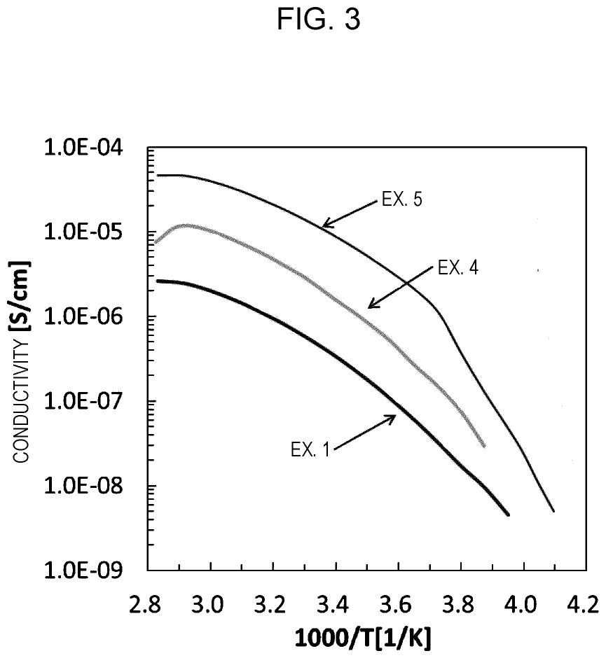

FIG. 3 is a graph illustrating the results of measurement of the temperature dependence of the conductivity of the fluoride ion conductive polymeric solid electrolytes obtained in EXAMPLE 1, EXAMPLE 4, and EXAMPLE 5. While the solid electrolyte of EXAMPLE 1 was free from branched side chains, the conductivity was observed to increase with increasing mass proportion of branched side chains. It is probable that the quantitative increase of the branched side chain structures enhanced the microscopic viscosity (that is, motility) of the polymer chains, and the ionic conductivity was enhanced as a result.

### Evaluation of Fluoride Ion Secondary Batteries

Charge/discharge evaluation was made of the fluoride shuttle batteries of EXAMPLE 1, EXAMPLE 3, EXAMPLE 5, EXAMPLE 6, and COMPARATIVE EXAMPLE 1. In the charge/discharge evaluation of the batteries, the batteries were tested with multichannel potentiostat VSP manufactured by Bio-LOGIC while being charged and discharged at a constant current of 1.87 μA/cm² with a lower limit voltage of −2.0 V and an upper limit voltage of 3.5 V. The measurement temperature was 60° C.

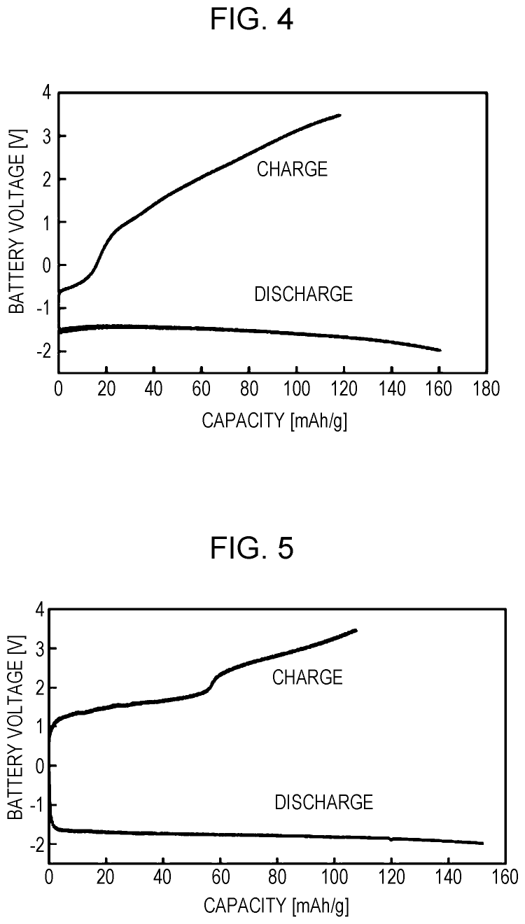

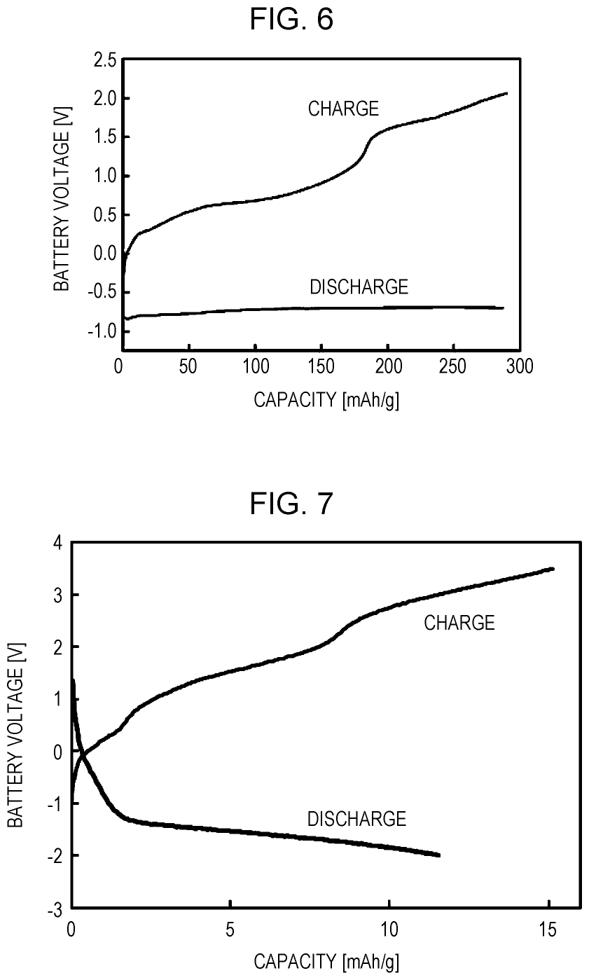

FIG. 4 is a graph illustrating the results of the charge/discharge test of the fluoride shuttle battery obtained in EXAMPLE 1. FIG. 5 is a graph illustrating the results of the charge/discharge test of the fluoride shuttle battery obtained in EXAMPLE 3. FIG. 6 is a graph illustrating the results of the charge/discharge test of the fluoride shuttle battery obtained in EXAMPLE 5. The batteries of EXAMPLES 1, 3, and 5 had Ag as the positive electrode active material and PSF as the negative electrode active material. The batteries of EXAMPLES 1, 3, and 5 had different types of electrolyte layers. EXAMPLE 1 used a polymeric solid electrolyte in which a polymer compound containing polyethylene oxide in the main chain (a PEO polymer) was used as the host polymer. In EXAMPLE 3, a composite solid electrolyte was used that included a PEO polymer and an inorganic solid electrolyte. EXAMPLE 5 used a polymeric solid electrolyte in which branched side chains had been introduced into a PEO polymer. All the batteries of EXAMPLES 1, 3, and 5 had high capacities exceeding 150 mAh/g.

FIG. 7 is a graph illustrating the results of the charge/discharge test of the fluoride shuttle battery obtained in EXAMPLE 6. EXAMPLE 6 differs from EXAMPLE 1 in that the positive electrode active material was changed from Ag to Cu. The battery was observed to have a capacity, although the capacity was as small as about 10 mAh/g.

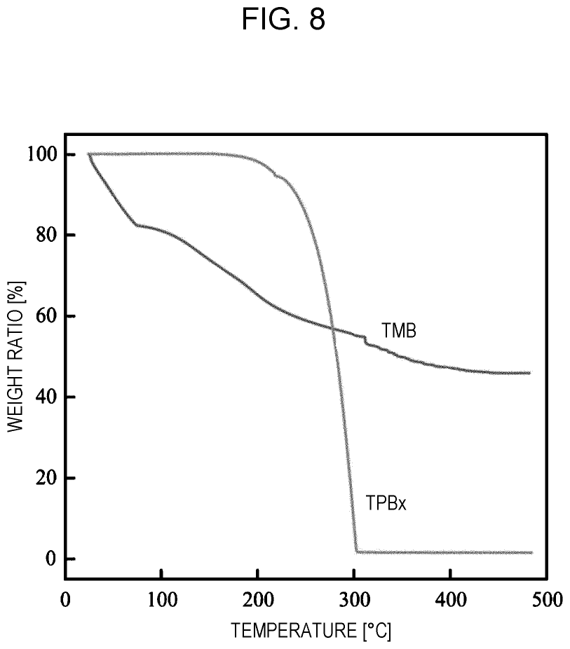

The battery of COMPARATIVE EXAMPLE 1 did not show any capacity and failed to operate as a battery. In order to investigate the cause of the failure, the thermal stability of the anion scavenger material was evaluated using a thermogravimeter (TG, Thermo plus Evo 2 manufactured by Rigaku Corporation). The change in weight was measured in a nitrogen atmosphere while increasing the temperature from 30° C. to 480° C. at a heat-up rate of 10° C./min. FIG. 8 is a graph illustrating the results of thermogravimetry of the compounds used as the anion scavenger materials in EXAMPLE 1 and COMPARATIVE EXAMPLE 1. Specifically, FIG. 8 illustrates the TG results of TPBx and TMB. TPBx exhibited almost no weight loss at 200° C. and below, while TMB lost weight even at about 50° C. The battery manufacturing involved heating at 60° C. or 120° C. It is therefore probable that TMB was sublimated in the heating process to lower the fluoride ion conductivity of the polymeric solid electrolyte, causing the battery to fail to operate.

The fluoride ion secondary battery of the present disclosure is not limited to the embodiments discussed hereinabove, and various modifications and alterations are possible without departing from the scope defined by the claims. For example, the technical features described in the embodiments may be appropriately replaced or combined in order to solve some or all of the problems discussed hereinabove or to achieve some or all of the advantageous effects described hereinabove. Furthermore, technical features that are not described as being essential in the specification may be appropriately omitted.

The fluoride ion conductive polymeric solid electrolyte of the present disclosure has excellent ion conductivity and is useful as a solid electrolyte that can offer a chargeable and dischargeable fluoride shuttle battery.

What is claimed is:

1. A fluoride ion conductive polymeric solid electrolyte comprising:
an ion conductive polymer;
a metal fluoride; and
an anion scavenger material, wherein
the anion scavenger material comprises a compound having a molecular weight of greater than or equal to 175.

2. The fluoride ion conductive polymeric solid electrolyte according to claim 1, wherein
when the compound included in the anion scavenger material is heated at a heat-up rate of 10° C./min, a temperature at which a weight of the compound is reduced to 80% of the weight of the compound at 30° C. is greater than or equal to 120° C.

3. The fluoride ion conductive polymeric solid electrolyte according to claim 1, wherein
the ion conductive polymer comprises a polyether polymer.

4. The fluoride ion conductive polymeric solid electrolyte according to claim 3, wherein
the polyether polymer comprises a polymer compound containing an alkylene oxide as a repeating unit in a molecule of the polymer compound, and
the polymer compound has a crosslinked structure.

5. The fluoride ion conductive polymeric solid electrolyte according to claim 4, wherein
the molecule of the polymer compound includes polyethylene oxide.

6. The fluoride ion conductive polymeric solid electrolyte according to claim 4, wherein
the polymer compound has a main chain including a polyether unit and a unit analogous to the polyether unit, and
the polyether unit has a structure including repetition of —CH₂CH₂O—.

7. The fluoride ion conductive polymeric solid electrolyte according to claim 4, wherein
the polymer compound contains a branched side chain having a free terminal chain.

8. The fluoride ion conductive polymeric solid electrolyte according to claim 1, wherein
the metal fluoride comprises sodium fluoride.

9. The fluoride ion conductive polymeric solid electrolyte according to claim 1, wherein
the metal fluoride comprises cesium fluoride.

10. The fluoride ion conductive polymeric solid electrolyte according to claim 1, wherein
the compound included in the anion scavenger material is 2,4,6-triphenylboroxine.

11. A composite solid electrolyte material comprising:
the fluoride ion conductive polymeric solid electrolyte according to claim 1; and
a fluoride ion conductive inorganic solid electrolyte.

12. The composite solid electrolyte material according to claim 11, wherein
the fluoride ion conductive inorganic solid electrolyte has a fluoride ionic conductivity of greater than or equal to 1×10⁻⁸ S·cm⁻¹ at 25° C.

13. A fluoride shuttle battery comprising:
a positive electrode;
a negative electrode; and
an electrolyte layer disposed between the positive electrode and the negative electrode, wherein
at least one selected from the group consisting of the positive electrode, the negative electrode, and the electrolyte layer comprises the fluoride ion conductive polymeric solid electrolyte according to claim 1.

14. The fluoride shuttle battery according to claim 13, wherein
the positive electrode comprises:
a positive electrode active material including a first metal element; and
a first solid electrolyte, and
the first solid electrolyte comprises the fluoride ion conductive polymeric solid electrolyte.

15. The fluoride shuttle battery according to claim 14, wherein
the first metal element is at least one selected from the group consisting of copper and silver.

16. The fluoride shuttle battery according to claim 13, wherein
the negative electrode comprises:
a negative electrode active material including a second metal element; and
a second solid electrolyte, and
the second solid electrolyte comprises the fluoride ion conductive polymeric solid electrolyte.

17. The fluoride shuttle battery according to claim 16, wherein
the second metal element is at least one selected from the group consisting of lead and tin.

18. The fluoride shuttle battery according to claim 13, wherein
the electrolyte layer comprises a third solid electrolyte, and
the third solid electrolyte comprises the fluoride ion conductive polymeric solid electrolyte.

19. A fluoride shuttle battery comprising:
a positive electrode;
a negative electrode; and
an electrolyte layer disposed between the positive electrode and the negative electrode, wherein
at least one selected from the group consisting of the positive electrode, the negative electrode, and the electrolyte layer comprises the composite solid electrolyte material according to claim 11.

20. The fluoride shuttle battery according to claim 19, wherein
the positive electrode comprises:
a positive electrode active material including a first metal element; and
a first solid electrolyte, and
the first solid electrolyte comprises the composite solid electrolyte material.

21. The fluoride shuttle battery according to claim 20, wherein
the first metal element is at least one selected from the group consisting of copper and silver.

22. The fluoride shuttle battery according to claim 19, wherein
the negative electrode comprises:
a negative electrode active material including a second metal element; and
a second solid electrolyte, and
the second solid electrolyte comprises the composite solid electrolyte material.

23. The fluoride shuttle battery according to claim 22, wherein
the second metal element is at least one selected from the group consisting of lead and tin.

24. The fluoride shuttle battery according to claim 19, wherein
the electrolyte layer comprises a third solid electrolyte, and
the third solid electrolyte comprises the composite solid electrolyte material.

25. A method for producing a fluoride shuttle battery, comprising:
forming a positive electrode including a first solid electrolyte and a positive electrode active material, the positive electrode active material including a first metal element;
forming an electrolyte layer by applying ultraviolet light to a mixture including a crosslinkable polymer, a metal fluoride, and an anion scavenger material to crosslink the crosslinkable polymer, the crosslinkable polymer containing polyethylene oxide in a molecule of the crosslinkable polymer;
forming a negative electrode including a second solid electrolyte and a negative electrode active material, the negative electrode active material including a second metal element; and
joining the positive electrode, the electrolyte layer, and the negative electrode into one piece by arranging the electrolyte layer between the positive electrode and the negative electrode.
